(19) United States
(12) Patent Application Publication
(10) Pub. No.: US 2017/0147901 A1
(43) Pub. Date: May 25, 2017

(54) MULTI-RESOLUTION, CHANGE-DRIVEN IMAGERY COLLECTION ASSET TASKING SYSTEM

(71) Applicant: The Boeing Company, Chicago, IL (US)

(72) Inventors: Robert J. Klein, Ballwin, MO (US); Ted L. Johnson, Florissant, MO (US); Anthony W. Baker, Gilbertsville, PA (US)

(21) Appl. No.: 14/947,619

(22) Filed: Nov. 20, 2015

(51) Int. Cl. G06K 9/62; G06T 7/00; G06F 17/30; G06K 9/00

(52) U.S. Cl. CPC G06K 9/6202; G06K 9/0063; G06T 7/001; G06F 17/30244; G06T 2207/30181

(57) ABSTRACT

A method includes receiving first and second images, each having a resolution that is less than or equal to a predetermined amount. The second image is captured at a different time than the first image, by a different sensor than the first image, or both. A common area is identified in both the first and second images. A probability of change in the common area between the first image and the second image is greater than a predetermined threshold. Third and fourth images are received, each having a resolution that is greater than or equal to the predetermined amount. The third and fourth images include the common area. The fourth image is captured at a different time than the third image, by a different sensor than the third image, or both. The fourth image has a total area that is less than a total area of the third image.

### TECHNICAL FIELD

The present teachings relate to the field of satellite image collection and, more particularly, to systems and methods for updating a portion of a satellite image where a change within the imaged area has occurred.

### BACKGROUND

Consumers of satellite images often order high-resolution satellite images on a regular basis. For example, a consumer may order high-resolution satellite images of a city once a year and high-resolution satellite images of agricultural areas even more frequently (e.g., once a month). Such high resolution images may be very expensive. For example, the cost of a high-resolution image of a city may exceed $100,000.

Sometimes it may be unnecessary for the consumer to order a large area of new high-resolution imagery when there are no changes within the imaged area represented by the old imagery and the new imagery. However, it can be very difficult and time consuming to manually compare the old and new images to determine if (and where) one or more changes to the area have occurred. What is needed, therefore, is a system and method for identifying a portion of an image where a change has occurred and updating only that portion of the imagery database at multiple resolutions.

### SUMMARY

The following presents a simplified summary in order to provide a basic understanding of some aspects of the present teachings. This summary is not an extensive overview, nor is it intended to identify key or critical elements of the present teachings, nor to delineate the scope of the disclosure. Rather, its primary purpose is merely to present one or more concepts in simplified form as a prelude to the detailed description presented later.

A method for obtaining an updated image is disclosed. The method includes receiving first and second images, each having a resolution that is less than or equal to a predetermined amount. The second image is captured at a different time than the first image, by a different sensor than the first image, or both. A common area is identified in both the first and second images. A probability of change in the common area between the first image and the second image is greater than a predetermined threshold. Third and fourth images are received, each having a resolution that is greater than or equal to the predetermined amount. The third and fourth images include the common area. The fourth image is captured at a different time than the third image, by a different sensor than the third image, or both. The fourth image has a total area that is less than a total area of the third image.

In another embodiment, the method includes receiving a first image and receiving a second image. A resolution of the first and second images is substantially the same and less than or equal to a predetermined amount. The second image is captured at a different time than the first image, by a different sensor than the first image, or both. The method also includes identifying a common geographic area in both the first and second images. A probability of change in the common geographic area between the first image and the second image is greater than a predetermined threshold. The method also includes receiving third and fourth images that each include the common geographic area. A resolution of the third and fourth images is substantially the same and greater than or equal to the predetermined amount. The fourth image is captured at a different time than the third image, by a different sensor than the third image, or both. A total area of the fourth image is substantially the same as the common area.

A computing system is also disclosed. The computing system includes one or more processors and a memory system including one or more non-transitory computer-readable media storing instructions that, when executed by at least one of the one or more processors, cause the computing system to perform operations. The operations include receiving first and second images, each having a resolution that is less than or equal to a predetermined amount. The second image is captured at a different time than the first image, by a different sensor than the first image, or both. A common area is identified in both the first and second images. A probability of change in the common area between the first image and the second image is greater than a predetermined threshold. Third and fourth images are received, each having a resolution that is greater than or equal to the predetermined amount. The third and fourth images include the common area. The fourth image is captured at a different time than the third image, by a different sensor than the third image, or both. The fourth image has a total area that is less than a total area of the third image.

The features, functions, and advantages that have been discussed can be achieved independently in various implementations or may be combined in yet other implementations further details of which can be seen with reference to the following description and drawings.

### BRIEF DESCRIPTION OF THE DRAWINGS

The accompanying drawings, which are incorporated in and constitute a part of this specification, illustrate the present teachings and together with the description, serve to explain the principles of the disclosure. In the figures:

FIG. 1 depicts a flowchart of a method for obtaining an up-to-date, high-resolution image, according to an embodiment.

FIG. 2 depicts an illustrative first image having a resolution that is less than or equal to a predetermined amount, according to an embodiment.

FIG. 3 depicts an illustrative second image having a resolution that is less than or equal to the predetermined amount, where the second image is captured or received after the first image, according to an embodiment.

FIG. 4 depicts the first image including a plurality of portions that have been selected, and FIG. 5 depicts the second image including a plurality of portions that have been selected, according to an embodiment.

FIG. 6 depicts the second image showing bounding boxes placed around the selected portions, according to an embodiment.

FIG. 7 depicts an illustrative third image having a resolution that is greater than or equal to the predetermined amount, according to an embodiment.

FIG. 8 depicts a computing system for performing the method, according to an embodiment.

It should be noted that some details of the Figures have been simplified and are drawn to facilitate understanding of the present teachings rather than to maintain strict structural accuracy, detail, and scale.

### DETAILED DESCRIPTION

Reference will now be made in detail to examples of the present teachings which are illustrated in the accompanying drawings. Wherever possible, the same reference numbers will be used throughout the drawings to refer to the same or like parts.

The systems and methods disclosed herein may compare a first (e.g., old) low resolution image and a second (e.g., newer) low resolution image. A common area in the first and second images may be identified where there is a high probability of change. The change may be, for example, a building that is present in the second image that is not present in the first image (e.g., because it was not built when the first image was taken). The same common area may be identified in a third (e.g., old) high resolution image. A fourth (e.g., newer) high resolution image may then be requested that has a total area that is less than the total area of the third image. For example, the total area of the fourth image may be the same as the common area in the third image. The fourth image may then be compared with the common area in the third image to determine whether there is, in fact, a change/difference between the two images (e.g., the house is present in the fourth image but not the third image). Thus, the system and method allow a user to request (e.g., pay for) a new high resolution image (e.g., the fourth image) that only includes the common area having a high probability of change. As a result, the user does not need to pay for a larger fourth image that includes areas that do not need to be analyzed because they do not have a high probability of change.

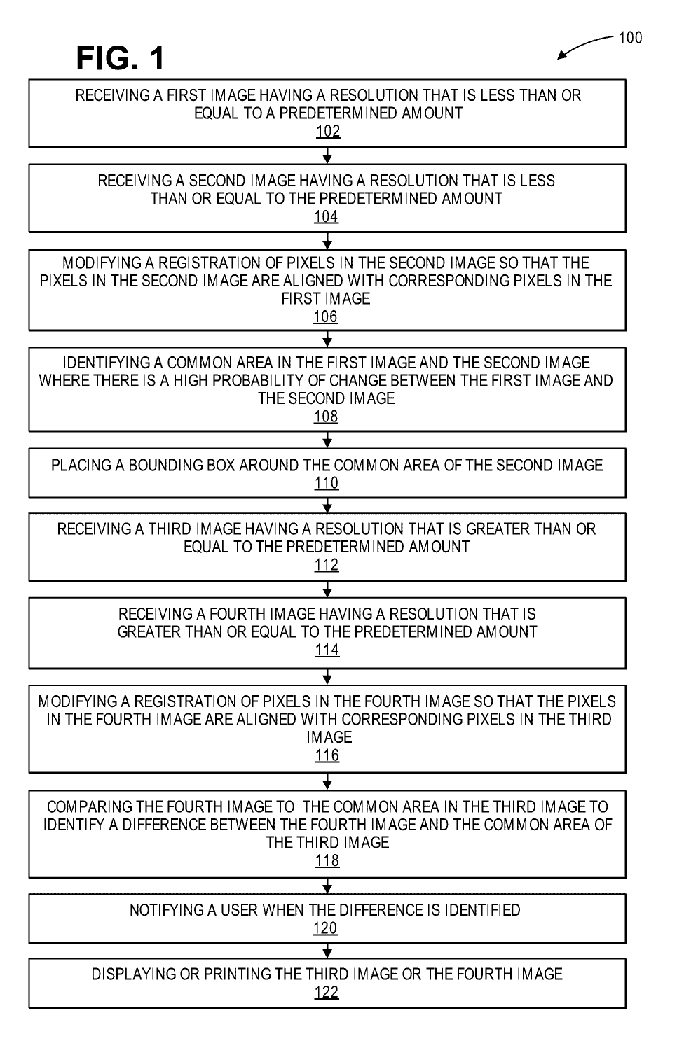

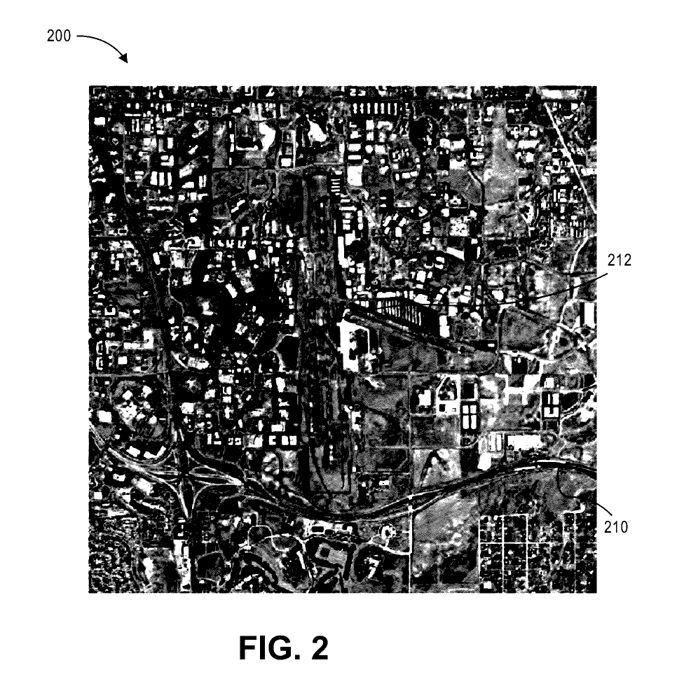

FIG. 1 depicts a flowchart of a method 100 for obtaining an up-to-date, high-resolution image, according to an embodiment. The method 100 may be described with reference to FIGS. 2-7, as will become apparent below. The method 100 may begin by receiving a first image having a resolution that is less than or equal to a predetermined amount, as at 102. The first image may be received or retrieved from a first database, where it may have been previously stored.

FIG. 2 depicts an illustrative first image 200 having a resolution that is less than or equal to a predetermined amount, according to an embodiment. The height and/or width of each pixel in the first image 200 may correspond to greater than or equal to 1 meter on the ground, greater than or equal to 5 meters on the ground, greater than or equal to 10 meters on the ground, or greater than or equal to 15 meters on the ground. Thus, the first image 200 may have a moderate or low resolution. Referring again to FIG. 1, the method 100 may also include receiving a second image having a resolution that is less than or equal to the predetermined amount (e.g., a moderate or low resolution image), as at 104. The second image may be received or retrieved from the first database or a different database.

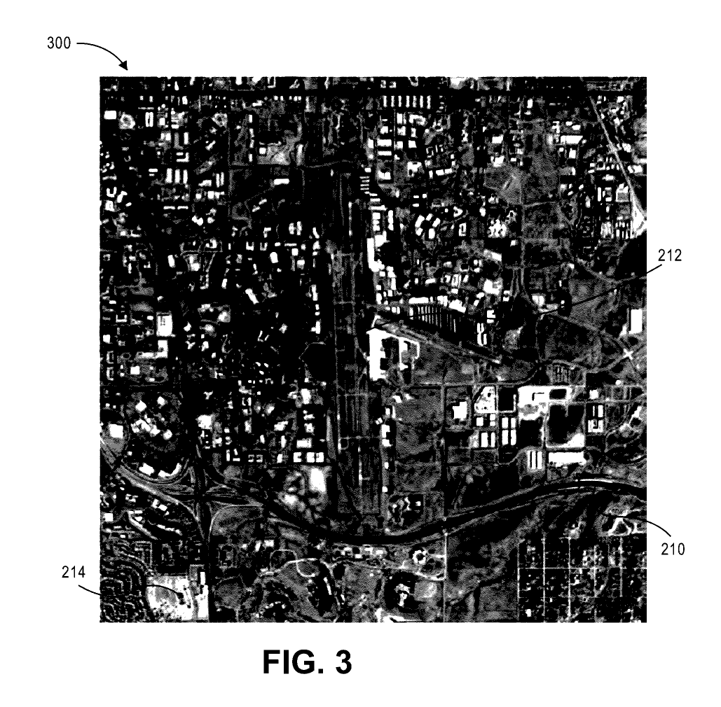

FIG. 3 depicts an illustrative second image 300 having a resolution that is less than or equal to the predetermined amount, according to an embodiment. The images 200, 300 in FIGS. 2 and 3 may be captured by a satellite, an airplane, a helicopter, an unmanned aerial vehicle, or the like. As shown, the images 200, 300 are overhead images captured by a satellite. Thus, a central longitudinal axis through the sensor/source (e.g., camera) that captures the images 200, 300 may be substantially perpendicular to the target (e.g., the ground area) being captured. However, in other embodiments, the images 200, 300 may be captured at various other (non-perpendicular) angles. The sensor/source may be or include a picture camera (e.g., an electro-optical camera), an infrared camera, a hyperspectral camera, a synthetic aperture radar, a light detection and ranging sensor/camera (“LIDAR”), a laser radar sensor/camera (“LADAR”), an ultraviolet sensor/camera, or the like.

The images 200, 300 may have been generated such that the resolution of the images 200, 300 is substantially the same. For example, the height and/or width of the pixels in the images 200, 300 may correspond to 10 meters on the ground.

The images 200, 300 are of the same geographic area/location and include many of the same landmarks (e.g., a road 210, a lake 212, etc.). The second image 300 may be captured at a different (e.g., later) time than the first image 200 (e.g., 1 year later). As a result, there may also be some differences/changes between the images 200, 300, as will be described in greater detail below. For example, the second image 300 may contain a building 214 that was not present at the time that the first image 200 was captured.

Referring again to FIG. 1, the method 100 may also include modifying a registration of the pixels in the second image 300 so that the pixels in the second image 300 are aligned with corresponding pixels in the first image 200, as at 106. For example, the pixels that represent the lake 212 in the second image 300 may not initially be aligned with the pixels that represent the lake 212 in the first image 200. To remedy this, the registration of the pixels in the second image 300 may be modified so that the pixels that represent the lake 212 in the second image 300 are aligned with the pixels that represent the lake 212 in the first image 200. In at least one embodiment, the modification of the registration of the pixels may be performed using an algorithm such as a general pattern matching (“GPM”) algorithm.

Referring again to FIG. 1, the method 100 may also include identifying a common area in the first image 200 and the second image 300 where there is a high probability of change between the first image 200 and the second image 300, as at 108. For example, the user may determine an accumulated probability of change for the total area in the first and second images 200, 300 over the time between which the first and second images 200, 300 are captured. The accumulated probability of change may be a predetermined amount or threshold, and areas in the first and second images 200, 300 having a probability above the threshold may be considered for additional processing.

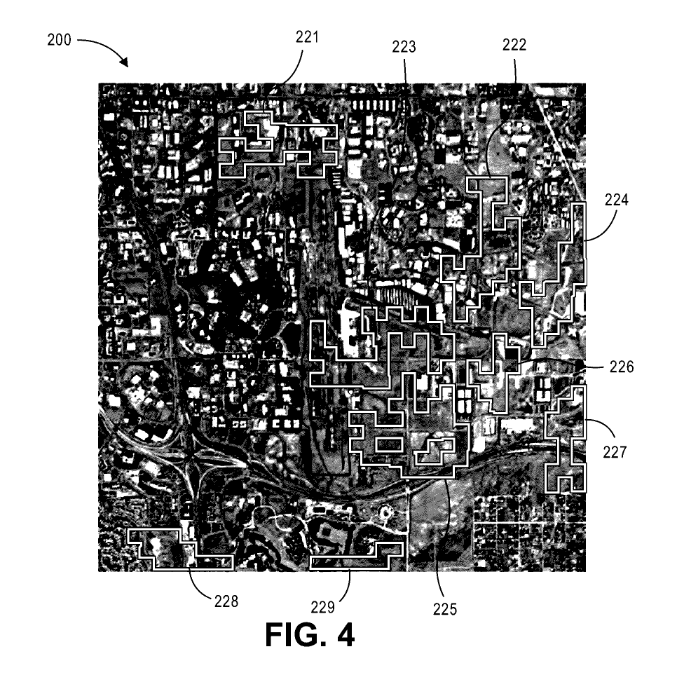

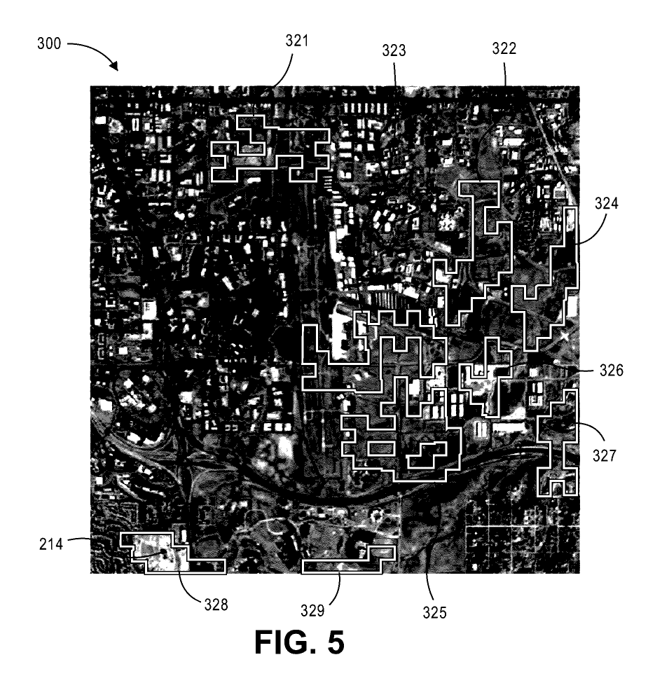

FIG. 4 depicts the first image 200 including a plurality of common areas 221-229 that have been identified, and FIG. 5 depicts the second image 300 including a plurality of common areas 321-329 that have been identified. The common areas 221-229, 321-329 may be or include portions of the first image 200 and/or the second image 300 that have few distinguishable landmarks (e.g., the road 210, the lake 212, etc.). For example, the common areas 221-229, 321-329 may be or include fields, parking lots, etc. where the pixels are substantially homogeneous. Each common area (e.g., area 228) in the first image 200 may have a corresponding common area (e.g., area 328) in the second image 300 such that when the images 200, 300 overlap, the common areas 228, 328 are aligned with one another.

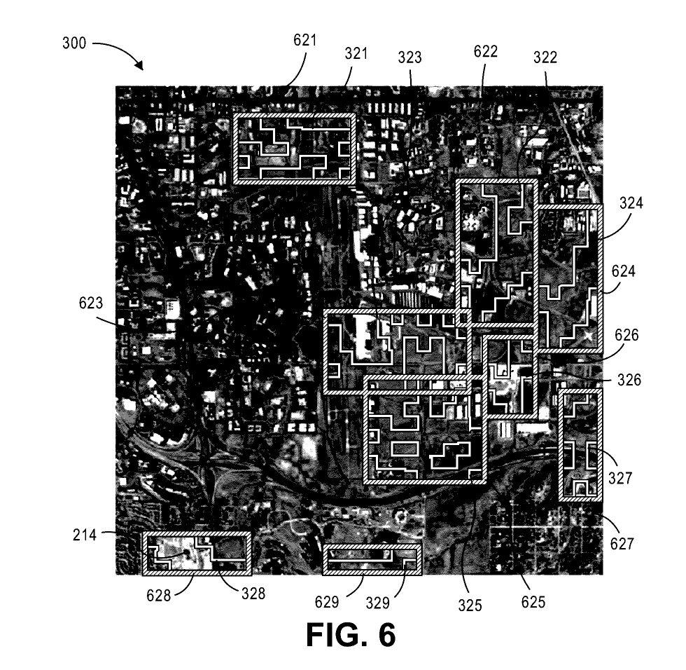

The common areas 221-229, 321-329 may have any shape or size. As may be seen, the common areas 221-229, 321-329 may be irregular geometric shapes. Referring again to FIG. 1, the method 100 may also include placing a bounding box around the common area 328 of the second image 300 (having a high probability of change), as at 110. FIG. 6 depicts the second image 300 including bounding boxes 621-629 placed around the common areas 321-329, according to an embodiment. The bounding boxes 621-629 may be rectangular.

Referring again to FIG. 1, the method 100 may also include receiving a third image having a resolution that is greater than or equal to the predetermined amount, as at 112. The third image may be received or retrieved from a second database. The first and second databases may be the same database, or they may be different databases.

The third image may include substantially the same total ground area as the first and second images 200, 300 (e.g., 5 kilometers×5 kilometers), and the third image may also include the common area (e.g., area 628: see FIG. 6). The third image may be captured or received before the second image 300. Thus, the third image may not be up to date and may not include the building 214, among other possible differences.

Referring again to FIG. 1, the method 100 may also include receiving or requesting a fourth image having a resolution that is greater than or equal to the predetermined amount, as at 114. The fourth image may be received or requested after the first image 200, the second image 300, and/or the third image is captured, received, or retrieved. The fourth image 400 may be received or requested in response to the probability of change in the common area (e.g., area 628) between the first image 200 and the second image 300 being greater than the predetermined threshold.

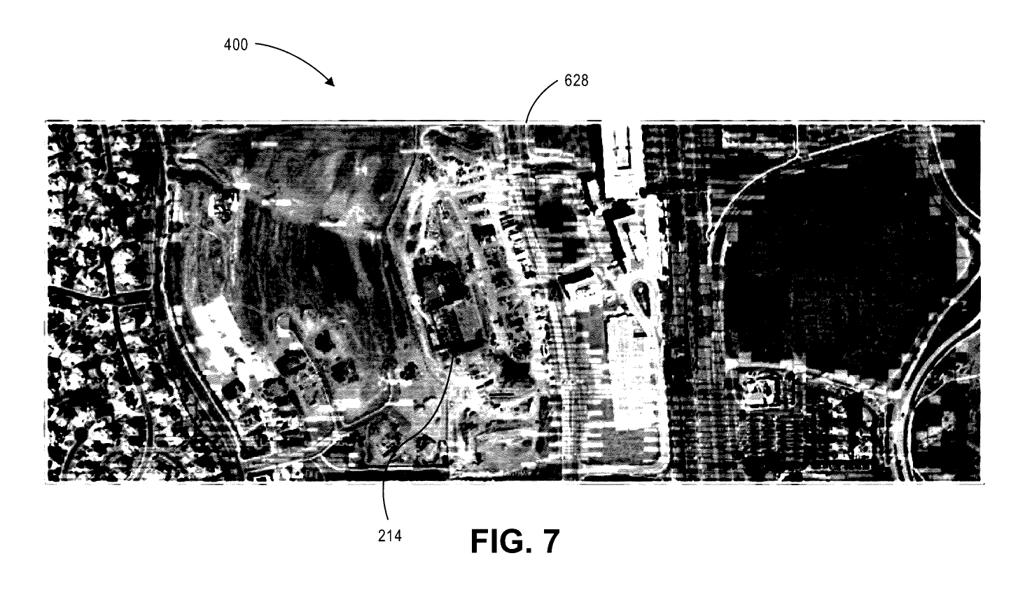

FIG. 7 depicts an illustrative fourth image 400 having a resolution that is greater than or equal to the predetermined amount, according to an embodiment. The height and/or width of each pixel in the fourth image 400 may correspond to less than or equal to 5 meters on the ground, less than or equal to 1 meter on the ground, or less than or equal to 50 centimeters on the ground. Thus, the fourth image 400 may have a high resolution.

The fourth image 400 may include some, but not all, of the total ground area shown in the first image 200, the second image 300, and/or the third image. More particularly, the fourth image 400 may include (e.g., only) the common area within the bounding box 628 (see FIG. 6). For example, the first and second images 200, 300 may each include a total ground area of 5 kilometers×5 kilometers, and the bounding box 628 and the fourth image 400 may include a total ground area of 300 meters×1 kilometer. Thus, as will be appreciated, the fourth image 400 may include only the area of concern (e.g., 300 meters×1 kilometer) rather than the total ground area (e.g., 5 kilometers×5 kilometers) in the first image 200, the second image 300, or the third image.

Referring again to FIG. 1, the method 100 may also include modifying a registration of pixels in the fourth image 400 so that the pixels in the fourth image 400 are aligned with corresponding pixels in the third image, as at 116. This may be similar to step 106 described above. The method 100 may also include comparing the fourth image 400 to the common area (e.g., area 628) of the third image to identify a difference (e.g., the house 214) between the fourth image 400 and the common area of the third image, as at 118. In some embodiments, the fourth image 400 may be stitched into the third image to produce an updated image.

The method 100 may also include notifying a user when the difference is identified, as at 120. The notification may be via an email, a text, an alarm, or the like. The method 100 may also include displaying or printing the third image or the fourth image 400, as at 122. The third image and/or the fourth image 400 may be displayed or printed in two-dimensional form or three-dimensional form.

The latest images may be stored in the first database and/or the second database. For example, the second image 300 may be stored so that, when the method 100 is run again in the future, the second image 300 may then be used as the first image 200 (and a new second image may be received). Similarly, the third image and/or the fourth image 400 may be stored for the same reasons.

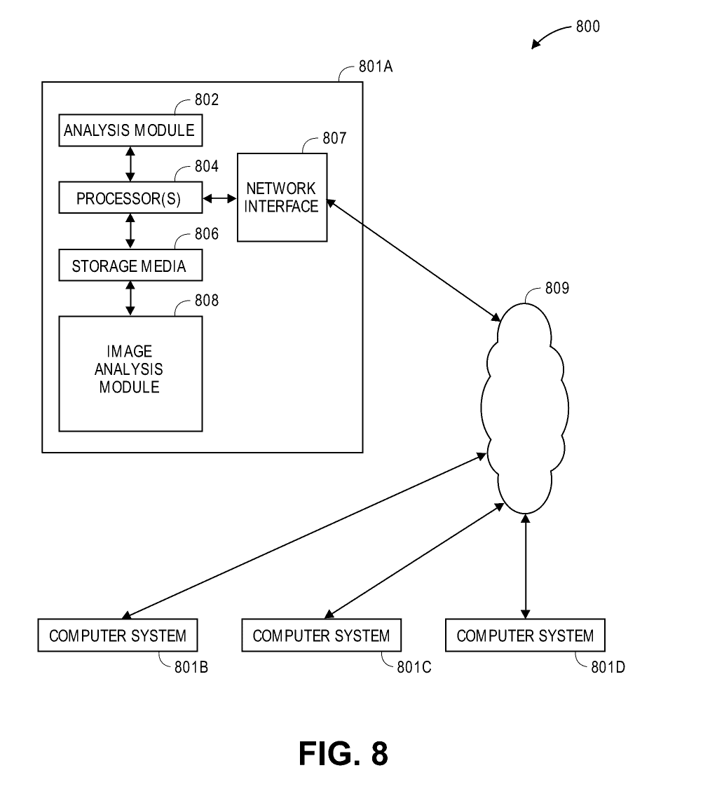

FIG. 8 depicts a computing system 800 for performing the method 100, according to an embodiment. The computing system 800 may include a computer or computer system 801A, which may be an individual computer system 801A or an arrangement of distributed computer systems. The computer system 801A includes one or more analysis modules 802 that are configured to perform various tasks according to some embodiments, such as one or more methods disclosed herein. To perform these various tasks, the analysis module 802 executes independently, or in coordination with, one or more processors 804, which is (or are) connected to one or more storage media 806A. The processor(s) 804 is (or are) also connected to a network interface 807 to allow the computer system 801A to communicate over a data network 809 with one or more additional computer systems and/or computing systems, such as 801B, 801C, and/or 801D (note that computer systems 801B, 801C and/or 801D may or may not share the same architecture as computer system 801A, and may be located in different physical locations, e.g., computer systems 801A and 801B may be located in a processing facility, while in communication with one or more computer systems such as 801C and/or 801D that are located in one or more data centers, and/or located in varying countries on different continents).

A processor can include a microprocessor, microcontroller, processor module or subsystem, programmable integrated circuit, programmable gate array, or another control or computing device.

The storage media 806A can be implemented as one or more computer-readable or machine-readable storage media. Note that while in the example embodiment of FIG. 8 storage media 806A is depicted as within computer system 801A, in some embodiments, storage media 806A may be distributed within and/or across multiple internal and/or external enclosures of computing system 801A and/or additional computing systems. Storage media 806A may include one or more different forms of memory including semiconductor memory devices such as dynamic or static random access memories (DRAMs or SRAMs), erasable and programmable read-only memories (EPROMs), electrically erasable and programmable read-only memories (EEPROMs) and flash memories, magnetic disks such as fixed, floppy and removable disks, other magnetic media including tape, optical media such as compact disks (CDs) or digital video disks (DVDs), BLUERAY® disks, or other types of optical storage, or other types of storage devices. Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

In some embodiments, computing system 800 contains one or more image analysis module(s) 808. The image analysis module 808 may be configured to run a GPM algorithm to compare two images (e.g., the first image 200 and the second image 300 or the third image and the fourth image 400) to one another to identify differences between the images.

It should be appreciated that computing system 800 is only one example of a computing system, and that computing system 800 may have more or fewer components than shown, may combine additional components not depicted in the example embodiment of FIG. 8, and/or computing system 800 may have a different configuration or arrangement of the components depicted in FIG. 8. The various components shown in FIG. 8 may be implemented in hardware, software, or a combination of hardware and software, including one or more signal processing and/or application specific integrated circuits.

Further, the steps in the processing methods described herein may be implemented by running one or more functional modules in information processing apparatus such as general purpose processors or application specific chips, such as ASICs, FPGAs, PLDs, or other appropriate devices. These modules, combinations of these modules, and/or their combination with general hardware are all included within the scope of protection of the invention.

Notwithstanding that the numerical ranges and parameters setting forth the broad scope of the present teachings are approximations, the numerical values set forth in the specific examples are reported as precisely as possible. Any numerical value, however, inherently contains certain errors necessarily resulting from the standard deviation found in their respective testing measurements. Moreover, all ranges disclosed herein are to be understood to encompass any and all sub-ranges subsumed therein. For example, a range of “less than 10” can include any and all sub-ranges between (and including) the minimum value of zero and the maximum value of 10, that is, any and all sub-ranges having a minimum value of equal to or greater than zero and a maximum value of equal to or less than 10, e.g., 1 to 5. In certain cases, the numerical values as stated for the parameter can take on negative values. In this case, the example value of range stated as “less than 10” can assume negative values, e.g. −1, −2, −3, −10, −20, −30, etc.

While the present teachings have been illustrated with respect to one or more implementations, alterations and/or modifications can be made to the illustrated examples without departing from the spirit and scope of the appended claims. It will be appreciated that structural components and/or processing stages can be added or existing structural components and/or processing stages can be removed or modified. Furthermore, to the extent that the terms “including,” “includes,” “having,” “has,” “with,” or variants thereof are used in either the detailed description and the claims, such terms are intended to be inclusive in a manner similar to the term “comprising.” The term “at least one of” is used to mean one or more of the listed items can be selected. Further, in the discussion and claims herein, the term “on” used with respect to two materials, one “on” the other, means at least some contact between the materials, while “over” means the materials are in proximity, but possibly with one or more additional intervening materials such that contact is possible but not required. Neither “on” nor “over” implies any directionality as used herein. The term “about” indicates that the value listed may be somewhat altered, as long as the alteration does not result in nonconformance of the process or structure to the present teachings. Finally, “exemplary” indicates the description is used as an example, rather than implying that it is an ideal. The present disclosure provides specific implementations without being exhaustive, and other implementations of the present teachings may be apparent to those skilled in the art from consideration of the specification and practice of the disclosure herein. It is intended that the specification and examples be considered as exemplary only, with a true scope and spirit of the present teachings being indicated by the following claims.

1. A method for obtaining an updated image, comprising:
receiving a first image having a resolution that is less than or equal to a predetermined amount;
receiving a second image having a resolution that is substantially the same as the first image, wherein the second image is captured after the first image;
comparing the second image to the first image to identify a common area in both the first and second images, wherein a probability of change in the common area between the first image and the second image is greater than a predetermined threshold;
receiving a third image having a resolution that is greater than or equal to the predetermined amount, wherein the third image includes the common area, and wherein the third image is captured before the second image;
receiving a fourth image having a resolution that is substantially the same as the third image in response to the probability of change being greater than the predetermined amount, wherein the fourth image is captured after the third image, and wherein the fourth image includes the common area and has a total area that is less than a total area of the third image;
comparing the fourth image to the common area in the third image to identify a change between the fourth image and the common area in the third image; and
replacing a portion of the third image with the fourth image in response to the change being identified.

2. The method of claim 1, wherein the total area of the fourth image is substantially equal to the common area.

3. (canceled)

4. The method of claim 1, further comprising notifying a user when the change is identified.

5. The method of claim 1, wherein identifying the common area in both the first and second images comprises using a pattern matching algorithm.

6. The method of claim 1, wherein the common area comprises a geographic area that is common to both the first and second images.

7. The method of claim 1, wherein the first image, the second image, the third image, the fourth image, or a combination thereof is captured by a satellite.

8. The method of claim 1, further comprising modifying a registration of pixels in the second image so that the pixels in the second image are aligned with corresponding pixels in the first image.

9. The method of claim 1, further comprising determining a probability of change for a total area in the first image, wherein the common area has a probability of change that is greater than the probability of change for the total area.

10. The method of claim 1, further comprising printing or displaying the fourth image.

11. A method for obtaining an updated image, comprising:
receiving a first image;
receiving a second image, wherein a resolution of the first and second images is substantially the same and less than or equal to a predetermined amount, and wherein the second image is captured than after the first image;
comparing the second image to the first image to identify a common geographic area in both the first and second images, wherein a probability of change in the common geographic area between the first image and the second image is greater than a predetermined threshold;
receiving a third image that includes the common geographic area, wherein the third image is captured before the second image;
receiving a fourth image that includes the common geographic area in response to the probability of change being greater than the predetermined amount, wherein a resolution of the third and fourth images is substantially the same and greater than or equal to the predetermined amount, wherein the fourth image is captured after the third image, and wherein a total area of the fourth image is substantially the same as the common area;
comparing the fourth image to the common area in the third image to identify a change between the fourth image and the common area in the third image; and
replacing a portion of the third image with the fourth image in response to the change being identified.

12. The method of claim 11, further comprising comparing the fourth image to the common geographic area in the third image to identify a change between the fourth image and the common geographic area in the third image.

13. The method of claim 12, further comprising notifying a user when the change is identified.

14. The method of claim 13, further comprising displaying or printing the fourth image.

15. The method of claim 11, wherein the total area of the fourth image substantially overlaps the common area.

16. A computing system comprising:
one or more processors; and
a memory system comprising one or more non-transitory computer-readable media storing instructions that, when executed by at least one of the one or more processors, cause the computing system to perform operations, the operations comprising:
receiving a first image having a resolution that is less than or equal to a predetermined amount;
receiving a second image having a resolution that is substantially the same as the first image, wherein the second image is captured at after the first image;
comparing the second image to the first image to identify a common area in both the first and second images, wherein a probability of change in the common area between the first image and the second image is greater than a predetermined threshold;
receiving a third image having a resolution that is greater than or equal to the predetermined amount, wherein the third image includes the common area,. and wherein the third image is captured before the second image;
receiving a fourth image having a resolution that is substantially the same as the third image in response to the probability of change being greater than the predetermined amount, wherein the fourth image is captured after the third image, and wherein the fourth image includes the common area and has a total area that is less than a total area of the third image;
comparing the fourth image to the common area in the third image to identify a change between the fourth image and the common area in the third image; and
replacing a portion of the third image with the fourth image in response to the change being identified.

17. The computing system of claim 16, wherein the first image is received from a first database, and the third image is received from a second database.

18. (canceled)

19. The computing system of claim 18, wherein the fourth image is received from a satellite.

20. The computing system of claim 16, wherein the operations further comprise displaying or printing the fourth image.

21. The method of claim 1, wherein an object is present in the second image and the fourth image, and wherein the object is not present in the first image and the third image.
